(19) United States
(12) Patent Application Publication
(10) Pub. No.: US 2025/0193363 A1
(43) Pub. Date: Jun. 12, 2025

(54) METHOD, DEVICE, AND COMPUTER PROGRAM PRODUCT FOR IMAGE GENERATION FOR PARTICULAR VIEW ANGLE

(71) Applicant: Dell Products L.P., Round Rock, TX (US)

(72) Inventors: Zhisong Liu, Shenzhen (CN); Zijia Wang, Weifang (CN); Sanping Li, Beijing (CN)

(21) Appl. No.: 18/406,979

(22) Filed: Jan. 8, 2024

(30) Foreign Application Priority Data
Dec. 11, 2023 (CN) 202311694232.7

(51) Int. Cl. H04N 13/279; G06T 7/73; G06T 7/90; G06T 9/00; G06T 17/00; G06V 10/44; G06V 10/80

(52) U.S. Cl. CPC H04N 13/279; G06T 7/73; G06T 7/90; G06T 9/00; G06T 17/00; G06V 10/44; G06V 10/806; G06T 2207/10024

(57) ABSTRACT

Embodiments of the present disclosure provide a method for image generation for a particular view angle. The method comprises acquiring a three-dimensional scene model, a target camera pose, and a target view angle corresponding to a target scene. The method further comprises determining a target compressed image feature corresponding to the target camera pose and the target view angle from a plurality of compressed image features. The method further comprises inputting the target camera pose, the target view angle, and the target compressed image feature to the three-dimensional scene model, and obtaining a target image corresponding to the target camera pose and the target view angle through rendering by the three-dimensional scene model. By using embodiments of the present disclosure, it is possible to acquire a more accurate rendered image from a target view angle while saving the storage memory and increasing the loading speed.

### RELATED APPLICATION

The present application claims priority to Chinese Patent Application No. 202311694232.7, filed Dec. 11, 2023, and entitled “Method, Device, and Computer Program Product for Image Generation for Particular View Angle,” which is incorporated by reference herein in its entirety.

### FIELD

Embodiments of the present disclosure relate to the field of image processing and, more specifically, to a method, a device, and a computer program product for image generation for a particular view angle.

### BACKGROUND

With the ongoing development of computer technologies and network technologies, the emerging neural rendering technology has brought new opportunities to computer graphics. Neural rendering is a generic name of various types of methods for image composition by deep networks, and various types of neural rendering aim to achieve all or part of the functions of modeling and rendering in graphics rendering. Among them, three-dimensional reconstruction of a scene based on a neural radiance field (NeRF) is an important topic in recent neural rendering, with the goal of achieving two-dimensional image generation from new view angles using neural networks.

### SUMMARY

Embodiments of the present disclosure relate to a method, a device, and a computer program product for image generation for a particular view angle.

According to a first aspect of the present disclosure, a method for image generation for a particular view angle is provided. The method comprises acquiring a three-dimensional scene model, a target camera pose, and a target view angle corresponding to a target scene. The method further comprises determining a target compressed image feature corresponding to the target camera pose and the target view angle from a plurality of compressed image features. The method further comprises inputting the target camera pose, the target view angle, and the target compressed image feature to the three-dimensional scene model, and obtaining a target image corresponding to the target camera pose and the target view angle through rendering by the three-dimensional scene model.

According to a second aspect of the present disclosure, an electronic device for image generation for a particular view angle is provided, comprising: at least one processor; and a memory coupled to the at least one processor and having instructions stored thereon, wherein the instructions, when executed by the at least one processor, cause the electronic device to perform actions comprising: acquiring a three-dimensional scene model, a target camera pose, and a target view angle corresponding to a target scene. The actions comprise determining a target compressed image feature corresponding to the target camera pose and the target view angle from a plurality of compressed image features. The actions comprise inputting the target camera pose, the target view angle, and the target compressed image feature to the three-dimensional scene model, and obtaining a target image corresponding to the target camera pose and the target view angle through rendering by the three-dimensional scene model.

According to a third aspect of the present disclosure, a computer program product is provided. The computer program product is tangibly stored on a non-transitory computer-readable medium and comprises machine-executable instructions, wherein the machine-executable instructions, when executed by a machine, cause the machine to perform steps of the method in the first aspect of the present disclosure.

### BRIEF DESCRIPTION OF THE DRAWINGS

By description of example embodiments of the present disclosure, provided in more detail herein with reference to the accompanying drawings, the above and other objectives, features, and advantages of the present disclosure will become more apparent. In the example embodiments of the present disclosure, the same reference numerals generally represent the same elements.

FIG. 1 illustrates a schematic diagram of a training process of a three-dimensional scene model according to embodiments of the present disclosure;

FIG. 2 illustrates a schematic diagram of a process for determining color values and density values using a plurality of multi-layer perceptrons according to embodiments of the present disclosure;

FIG. 3 illustrates a schematic diagram of an inference process of a three-dimensional scene model according to embodiments of the present disclosure;

FIG. 4 illustrates a flow chart of a method for image generation for a particular view angle according to embodiments of the present disclosure;

FIG. 5 illustrates a schematic diagram of a process for generating a two-dimensional image for a particular view angle using a three-dimensional scene model according to embodiments of the present disclosure;

FIG. 6 illustrates a schematic diagram of an example inference for an image of a next view angle using an image sequence according to embodiments of the present disclosure;

FIG. 7 illustrates a schematic diagram of a process for interpolating a video sequence using a three-dimensional scene model according to embodiments of the present disclosure;

FIG. 8 illustrates a schematic diagram of interpolating a video sequence according to embodiments of the present disclosure; and

FIG. 9 illustrates a schematic block diagram of an example device which may be used to implement embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

The neural radiance field is a technique for reconstructing a three-dimensional scene using multiple two-dimensional images, which can represent a three-dimensional scene using a fully-connected network to which the input thereof is a continuous 5-dimensional coordinate: a spatial position (x, y, z) and a view angle direction (θ, ϕ), from which the outputs are the volume density and view angle-related color information at that spatial position. Afterwards, the neural radiance field can be further combined with the volume rendering technique to project the outputted color information and volume density onto a two-dimensional image, thus enabling image composition from a particular view angle.

However, in the process of rendering two-dimensional images from different view angles using the neural radiance field, relying only on the camera pose and view angle information to determine the corresponding color information and depth information results in low quality of the rendered target images (e.g., blurriness and lack of details) and inefficiency in generation of the target images.

At least to address the above and other potential problems, embodiments of the present disclosure provide a method for image generation for a particular view angle. The method comprises acquiring a three-dimensional scene model, a target camera pose, and a target view angle corresponding to a target scene. The method further comprises determining a target compressed image feature corresponding to the target camera pose and the target view angle from a plurality of compressed image features. The method further comprises inputting the target camera pose, the target view angle, and the target compressed image feature to the three-dimensional scene model, and obtaining a target image corresponding to the target camera pose and the target view angle through rendering by the three-dimensional scene model. By using this method, in the process of determining the target image, the target compressed image feature is used as a reference basis and auxiliary condition for generating the target image, which can improve the generation quality and generation efficiency of the target image.

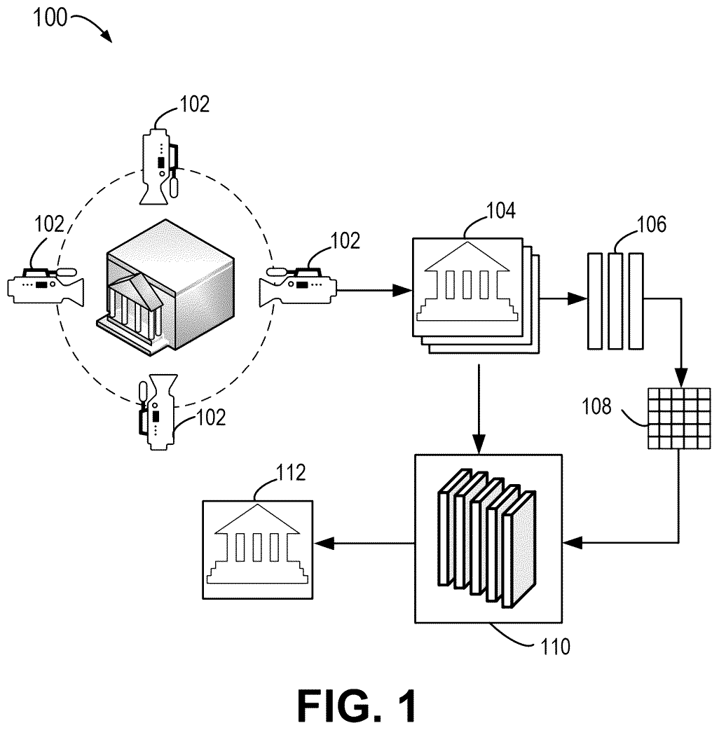

When obtaining a two-dimensional picture or a three-dimensional picture from a particular view angle through rendering using a three-dimensional scene model, it is necessary to carry out a three-dimensional reconstruction of the target scene, that is, it is necessary to first train the three-dimensional scene model so that the three-dimensional scene model obtained through the training learns a scene representation for this target scene. The training process of the three-dimensional scene model is described in detail below in conjunction with FIG. 1. FIG. 1 illustrates a schematic diagram of a training process 100 of a three-dimensional scene model.

As shown in FIG. 1, a capturing device 102 can capture images for a target scene at different positions and from different view angles, wherein the target scene may be a real world scene or may also be a virtual world scene model. The target scene may contain a plurality of target objects in the real environment or the virtual environment, such as pedestrians, vehicles, buildings, and the like. The capturing device 102 is an electronic device having image capture capability and data transmission capability. For example, the capturing device 102 may be a video camera, a camera, or a terminal device (e.g., a cell phone, a personal computer, a tablet computer, etc.) with the image capture capability.

In FIG. 1, the capturing device 102 may photograph the target scene to obtain images 104 or to obtain a video stream. When the capturing device 102 obtains a video stream by means of photographing, it may decode the video stream to obtain several frames of images, and then obtain captured images 104 from the above-mentioned several frames of images. The capturing device 102 may send a plurality of images 104 captured to the three-dimensional scene model to train the three-dimensional scene model, so that the trained three-dimensional scene model is capable of learning the scene representation of that target scene. In this way, the trained three-dimensional scene model is capable of generating images at any position from any view angle.

In FIG. 1, the plurality of images 104 captured by the capturing device 102 may be sequentially inputted to a feature extraction module 106 of the three-dimensional scene model, and image features of the inputted images 104 are separately extracted by the feature extraction module 106. Among them, the image features may include color features, texture features, shape features, spatial relationship features, and the like. In practical application environments, in order to make the scene representation learned by the three-dimensional scene model more accurate and new-view angle images generated subsequently more accurate, it is generally necessary to utilize a large number of images to train the three-dimensional scene model. In this case, on the one hand, the storage space occupied by the image features that need to be stored is large, and on the other hand, the learning efficiency of the three-dimensional scene model is low. On this basis, in order to solve the above problem, the feature extraction module 106 may compress the image features and use the compressed image features that have been compressed to train the three-dimensional scene model, so as to improve the training efficiency and save the storage space. Further, the trained three-dimensional scene model is also capable of learning more image features, and the generated target image is of higher image quality.

In FIG. 1, the feature extraction module 106 may compress the image features in accordance with a preset compression coefficient to obtain a compressed image feature 108, wherein the preset compression coefficient may be set by a user according to the storage requirement and the computation speed. The neural radiance field module 110 of the three-dimensional scene model may process the compressed image feature 108 and obtain, based on the compressed image feature 108, a rendered image that has been rendered, wherein the neural radiance field module 110 may include a plurality of multi-layer perceptrons (MLPs). The multi-layer perceptron may predict the volume density and color information at different positions based on the view angle information and the position information contained in the compressed image feature.

In FIG. 1, after obtaining the rendered image 112 corresponding to the inputted images 104 through rendering using the three-dimensional scene model, network parameters of the three-dimensional scene model may be iteratively adjusted based on differences between the rendered image 112 and the images 104 until the iteration satisfies a preset requirement. In the case where the iteration satisfies the preset requirement, the trained three-dimensional scene model and the corresponding network parameters can be acquired. It is to be noted that after the training of the three-dimensional scene model is completed, the compressed image features generated during the training process and the network parameters of the three-dimensional scene model may be stored locally or to a cloud.

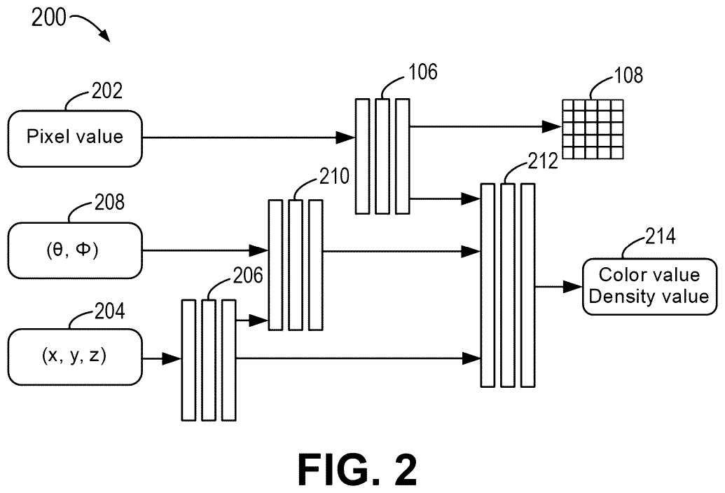

FIG. 2 illustrates a schematic diagram of a process 200 for determining color values and density values using a plurality of multi-layer perceptrons. As shown in FIG. 2, the feature extraction module 106 (e.g., a vision transformer (ViT) neural network) may encode image features 202 to obtain position embeddings (not shown in the figure) corresponding to the inputted images. The position embeddings may then be compressed to determine the compressed image feature 108. As an example, the compressed image feature 108 may be a one-dimensional vector. In the present disclosure, the compressed image feature 108 corresponding to the inputted images may be stored locally or to a cloud, so that in the process of generating an image from a new view angle, this compressed image feature 108 may be called and used as an auxiliary condition and reference basis for generating the image from a new view angle.

In FIG. 2, the input information to a first multi-layer perceptron 206 is position information 204 of a sampling point. The position information may be represented using three-dimensional position coordinates (x, y, z). The first multi-layer perceptron 206 may process the inputted three-dimensional position coordinates and output the volume density (not shown in the figure) corresponding to this sampling point. The input information to a second multi-layer perceptron 210 is the view angle direction (θ, ϕ) 208 corresponding to that sampling point and the output information from the first multi-layer perceptron 206. The output information from the second multi-layer perceptron 210 is a color value (not shown in the figure) corresponding to this sampling point. The input information to a third multi-layer perceptron 212 is the compressed image feature 108, the output information from the second multi-layer perceptron 210, and the output information from the first multi-layer perceptron 206. The output information from the third multi-layer perceptron 212 is the color value and volume density 214 of this sampling point.

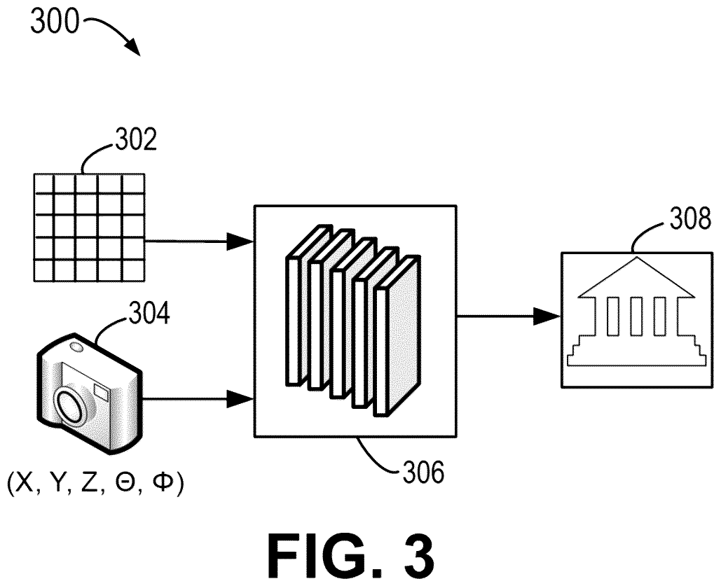

It can be understood that after training of the three-dimensional scene model is completed, the three-dimensional scene model can learn a three-dimensional structure of the target scene. From another perspective, the target scene is implicitly stored in the network parameters of the three-dimensional scene model. In this way, the trained three-dimensional scene model can generate a two-dimensional image from any view angle. FIG. 3 illustrates a schematic diagram of an inference process 300 of a three-dimensional scene model according to some embodiments of the present disclosure. As shown in FIG. 3, a user can input, in conjunction with his or her own needs, a target view angle and target camera pose 304 corresponding to a two-dimensional image that the user wants to view. In this process, a target compressed image feature 302 corresponding to the target view angle and target camera pose 304 can be acquired from a cloud or locally. Afterwards, the target compressed image feature 302 and the target view angle and target camera pose 304 are inputted together to a three-dimensional scene model 306 corresponding to the target scene, and a corresponding target image 308 is obtained through rendering by the three-dimensional scene model 306.

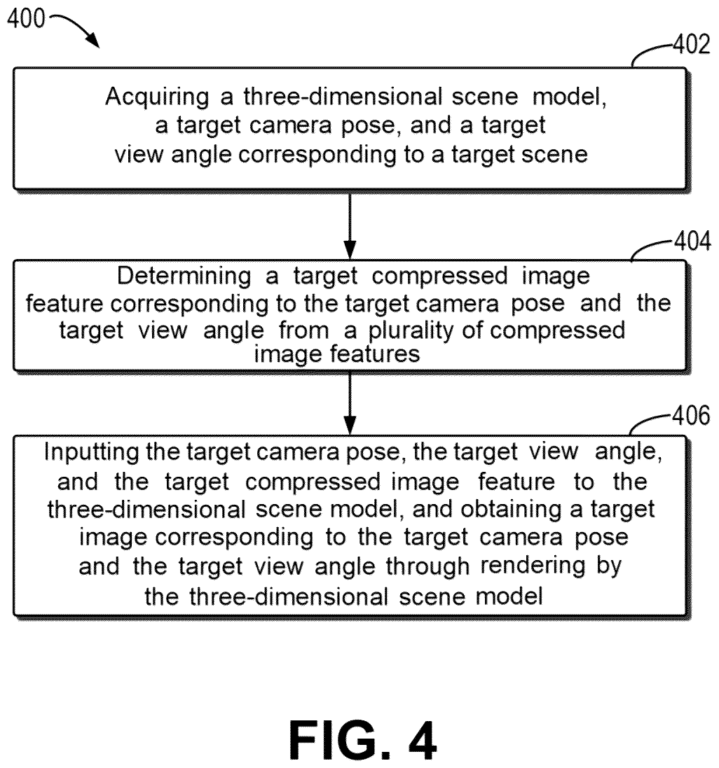

FIG. 4 illustrates a flow chart of a method 400 for image generation for a particular view angle according to some embodiments of the present disclosure. The method 400 may be executed by a computing device, which may be a user terminal, a mobile device, a computer, etc., and/or by a computing system, a single server, a distributed server, a cloud-based server, or the like. As shown in FIG. 4, at a block 402, a three-dimensional scene model, a target camera pose, and a target view angle corresponding to a target scene can be acquired. Different target scenes correspond to different three-dimensional scene models, wherein the three-dimensional scene model may be obtained through training using a plurality of image samples obtained by photographing the target scene (the training process is as shown in FIG. 1).

In the present disclosure, the target camera pose refers to the position and posture of the camera in space, and the camera pose can be characterized using camera extrinsic parameters, wherein the camera extrinsic parameters describe the orientation and origin of the camera coordinate system. The target view angle may be used to characterize the position and the angle when observing that target scene. The method for image generation for a particular view angle in embodiments of the present disclosure is to render an image that is presented when that target scene is viewed at the position and the angle characterized by the target view angle. As an example, a user may input the target view angle and the target camera pose through a human-computer interaction interface. Of course, the user may also generate the target view angle by performing rotation and translation operations on the target scene displayed in the human-computer interaction interface. The target view angle may be expressed using pitch angle, yaw angle, and so on.

As shown in FIG. 4, at a block 404, since the three-dimensional scene model will generate compressed image features corresponding to different image samples during the training process, and these compressed image features will be stored locally or to a cloud after the training of the three-dimensional scene model is completed, a target compressed image feature corresponding to the target view angle and the target camera pose can be determined from a plurality of compressed image features stored locally or to the cloud. In some embodiments, being corresponding means that the view angle and camera pose corresponding to the target compressed image feature are the same as the target view angle and the target camera pose, or the view angle difference between the view angle corresponding to the target compressed image feature and the target view angle satisfies a preset requirement. As an example, a simultaneous localization and mapping (SLAM) algorithm may be used to determine the camera pose corresponding to each compressed image feature.

As shown in FIG. 4, at a block 406, the target camera pose, the target view angle, and the target compressed image feature may be inputted to the three-dimensional scene model, and a corresponding target image may be obtained through rendering by the three-dimensional scene model. As an example, the target compressed image feature may be decoded to determine a decoded image feature. Afterwards, the three-dimensional scene model may determine a ray emitted from any pixel in the decoded image feature to the target scene along the camera pose direction. A plurality of sampling points may be selected along the ray in the three-dimensional space, wherein the number of the sampling points may be set according to actual needs, for example, any value between 60 and 128, and embodiments of the present disclosure do not impose specific limitations thereon. The density and color at the sampling point may be obtained by the radiance field function of the three-dimensional scene model, after which the colors on the ray are superimposed to implement the rendering of single pixels. It can be understood that by repeating the above operations for all pixels on this decoded image feature, the rendered target image can be obtained.

By the above method, when generating the target image corresponding to the target view angle and the target camera pose, the corresponding compressed image feature can be used as the image generation condition and reference basis, so that the target image from a particular view angle can be generated in an efficient, quick, and accurate manner.

In some embodiments, a neural radiance field module may be contained in the three-dimensional scene model, and the neural radiance field is capable of optimizing a radiance field function of the scene using an MLP network, wherein the radiance field function is represented by Equation (1) below:

$${F}_{θ} : ( X , d ) \to ( c , σ ) \qquad ( 1 )$$

where X=(x, y, z) and denotes the three-dimensional coordinates of the sampling point. d=(θ, ϕ) and denotes the view angle (direction of observation). As an example, θ is the azimuth angle, and ϕ is the elevation angle. c=(r, g, b) and denotes the corresponding color at that sampling point, and a denotes the volume density.

It can be understood that after determining the position of the sampling point and the direction of observation according to the target camera pose and the target view angle, the neural radiance field module can predict the color and volume density at that sampling point based on the above Equation (1). Afterwards, the neural radiance field module may use volume rendering to generate a rendered target image. For example, the neural radiance field module may determine a predicted value C(r) for each pixel color in the target image using the following Equation (2):

$$C ( r ) = {\int }_{{t}_{n}}^{{t}_{f}} T ( t ) σ ( r ( t ) ) c ( r ( t ) , d ) dt , where T ( t ) = exp ( - {\int }_{{t}_{n}}^{t} σ ( r ( s ) ) ds ) \qquad ( 2 )$$

where r(t)=o+td and denotes the camera ray, and where o is the ray origin, d denotes a ray direction calculated from camera parameters (e.g., the camera spatial position and the camera orientation), t denotes the distance between a sampling point on the ray and the ray origin, and the near and far boundaries of the ray are denoted as tₙ and t_{f}, respectively.

In some embodiments, in order to improve the quality and efficiency of the generation of the target image, when generating the corresponding target image, the pixel value of the compressed image feature corresponding to the target view angle and the target camera pose may be used as the reference basis for determining the pixel value at the corresponding position of the target image. In this way, the determined pixel values are more accurate, and the generated target image has clearer details and higher image quality. For example, the pixel value of each pixel of the target image can be determined using the following Equation (3):

$$y {*}_{i , j} = {\sum }_{i = 0}^{M} {\sum }_{j = 0}^{N} {\sum }_{t = 0}^{2} f ( {z}_{t} , \times σ ( 1 + {\int }_{i , j , t} ) + μ ( {\int }_{i , j , t} ) ) \qquad ( 3 )$$

where y*_{i,j} is the pixel value of the target image at (i,j), and M and N are the width and height of the target image. ∫_{i,j} is the pixel value at the corresponding position of the target compressed image feature. σ and μ are the variance and mean operators, respectively. The ƒ( ) function is a neural radiance field function.

In some embodiments, the neural radiance field module may further comprise a plurality of MLPs, for example, a first MLP, a second MLP, and a third MLP (e.g., the three MLPs shown in FIG. 2). The input information to the first MLP is position information of the sampling point, such as three-dimensional position coordinates (x, y, z) of the sampling point. The output information from the first MLP is the volume density corresponding to that sampling point. The input information to the second MLP is the view angle direction (θ, ϕ) corresponding to that sampling point and the output information from the first MLP. The output information from the second MLP is the color value corresponding to that sample point. The input information to the third MLP is the embedding corresponding to the target compressed image feature, the output information from the first MLP, and the output information from the second MLP. The output information from the third MLP is the color value and the volume density of that sampling point.

In some embodiments, a user may view the two-dimensional images of the target scene from different view angles according to actual application requirements. For example, the user may input, on a human-computer interaction interface, the target view angle and the corresponding camera pose that the user wants to view. Afterwards, the human-computer interaction interface may receive the input information from the user and generate the corresponding image generation instruction, and by analyzing the image generation instruction, the target camera pose and the target view angle can be determined. It can be understood that after obtaining the target image corresponding to the target camera pose and the target view angle through rendering using the three-dimensional scene model, this target image may be returned to the human-computer interaction interface for display, so that the user can view it.

It can be understood that before using the three-dimensional scene model to generate a corresponding two-dimensional image of the target scene from that target view angle, it is necessary to train the three-dimensional scene model such that the three-dimensional scene model can learn a scene representation of that target scene. In some embodiments, an image capturing device or other terminal devices having an image capture unit may be used to capture image samples for the target scene. For example, a plurality of image samples may be acquired by photographing the target scene at different shooting positions and using different view angles. As an example, the image capturing device may photograph the target scene in a 360 degree surrounding manner around the target scene to obtain a plurality of image samples of the target scene. Additionally or alternatively, a plurality of image samples may also be acquired by other means. For example, a plurality of image samples are acquired by downloading a training data set from the Internet.

As an example, the terminal device may also be an electronic device having both a display screen and an image capture unit, which can both photograph a target object in a target scene by the image capture unit to generate a two-dimensional image, and display, by the display screen, the two-dimensional image generated through photographing and the two-dimensional image with a particular view angle that is generated by a three-dimensional reconstruction module.

The three-dimensional scene model is constructed, which is configured with network parameters, wherein the three-dimensional scene model may be a machine learning model based on a neural radiance field. In some embodiments, before inputting the plurality of image samples to the three-dimensional scene model, the image samples may be pre-processed to improve the training efficiency. The pre-processing approach may include operations on the image samples such as rotating, scaling, color adjusting, cropping, replacing the background, and the like.

In some embodiments, the constructed three-dimensional scene model includes a feature extraction module and a neural radiance field module, wherein the feature extraction module (e.g., the feature extraction module 106 shown in FIG. 1) may extract image features of the image samples, perform position encoding of the image features, and compress the position-encoded embeddings in accordance with a preset compression coefficient. For example, the feature extraction module may encode the image samples using a cosine function or a sine function to determine corresponding position embeddings of the image samples. Afterwards, the position embeddings may be compressed in accordance with the preset compression coefficient. As an example, the bit rate of the input image X is b(X), the bit rate of the compressed image feature that has been compressed is b(S), and b(X)=λb(S) in the case where the preset compression coefficient is λ.

It can be understood that after the image samples are input to the three-dimensional scene model, a camera pose and a camera view angle corresponding to each of the image samples may be calculated using a pose calculation method. Afterwards, a rendered image corresponding to the inputted image samples may be obtained through rendering using the neural radiance field module based on the camera poses, the camera view angles, and the compressed image features (for the rendering process, the details can be found in the rendering process described in the above embodiment, which will not be repeated herein). As an example, the following Equation (4) may be used to determine the pixel value at each position of the rendered image:

$${y}_{i , j} = {\sum }_{i = 0}^{M} {\sum }_{j = 0}^{N} f ( z , \times σ ( 1 + {\int }_{i , j} ) + μ ( {\int }_{i , j} ) ) \qquad ( 4 )$$

wherein y_{i,j} is the pixel of the rendered image, and M and N are resolutions of the rendered image. ∫_{i,j} is the pixel value at the corresponding position of the compressed image feature. σ and μ are the variance and mean operators, respectively. The ƒ( ) function is a neural radiance field function.

It can be understood that after generating the rendered image, the three-dimensional scene model can be trained based on the differences between the rendered image and the image samples, and the network parameters of the three-dimensional scene model can be iteratively adjusted until the differences between the rendered image and the image samples satisfy a preset requirement, wherein the iteration satisfying the preset requirement may include the differences between the rendered image and the image samples being less than a difference threshold, where the difference threshold may be set, for example, to 0.01, 0.05, and the like. Of course, the iteration satisfying the preset requirement may also include the number of iterations being greater than a preset number threshold, where the preset number threshold may be set, for example, to 50, 60, and the like. Further, the differences between the rendered image and the image samples may be represented using a loss function.

It should be emphasized that for any set of image samples, the feature extraction module and the neural radiance field module may be jointly trained or may be separately and independently trained. Of course, in order to save training costs, the feature extraction module may not be trained after determining the preset compression coefficient.

In some embodiments, after the training of the three-dimensional scene model is completed, the compressed image features corresponding to the image samples for training may be stored to a cloud or locally for subsequent calling. Further, the network parameters of the three-dimensional scene model obtained after the training is completed may also be stored locally or to the cloud, so that the three-dimensional scene model can reconstruct the three-dimensional structure of the target scene.

In some embodiments, the three-dimensional scene model may, after the training is completed, determine a camera movement trajectory according to the camera poses and the camera view angles corresponding to the image samples for training. As an example, three coordinate axes (x, y, z) can be plotted using the origin of the camera pose for each of the image samples plus three coordinate axis vectors for that camera pose. The camera movement trajectory of the camera can be determined by representing each of the three coordinate axes (x, y, z) with the colors (red, green, and blue) and connecting the origins of the camera poses corresponding to all the image samples using white line segments. Further, the camera movement trajectory may be stored locally or to the cloud.

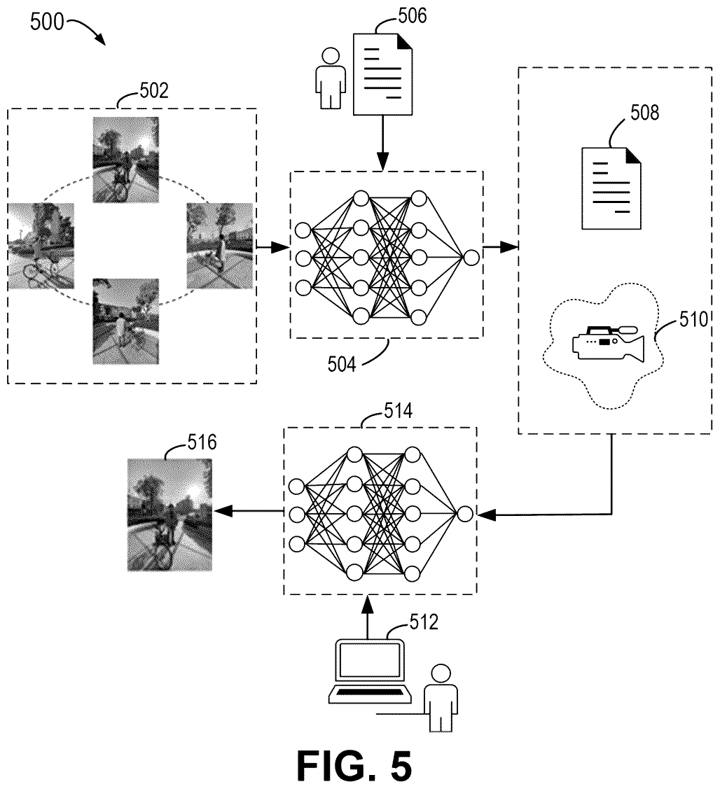

In some embodiments, in order to perform inference on the target scene and determine two-dimensional images of the target scene from various angles, a three-dimensional scene model may be used to generate two-dimensional images from particular view angles. FIG. 5 illustrates a schematic diagram of a process 500 for generating a two-dimensional image from a particular view angle using a three-dimensional scene model. As shown in FIG. 5, an image sequence 502 captured by an image capturing device may be input to a three-dimensional scene model 504 to train the three-dimensional scene model 504. As an example, during the training process, the three-dimensional scene model 504 may be used to learn and reconstruct the three-dimensional structure of the three-dimensional scene hidden in the image sequence 502. During the training process, the user may set a preset compression coefficient 506 according to the actual application requirements, and input the preset compression coefficient 506 to the three-dimensional scene model 504, so that the image features are compressed by the three-dimensional scene model 504.

As shown in FIG. 5, after the training of the three-dimensional scene model 504 is completed, network parameters 508 of the three-dimensional scene model corresponding to the image sequence 502 and a camera movement trajectory file 510 can be obtained. When the user needs to view a two-dimensional image of the target scene from a certain view angle, a target view angle 512 that needs to be queried may be inputted in a human-computer interaction interface. Afterwards, this target view angle 512 can be inputted to the trained three-dimensional scene model 514, and a corresponding target image 516 can be outputted from the trained three-dimensional scene model 514. Finally, the target image 516 can be sent to the display screen of the human-computer interaction interface for display, so that the user can view it. In this way, the user can explore the three-dimensional space of the target scene at will and can find the two-dimensional image corresponding to the desired view angle.

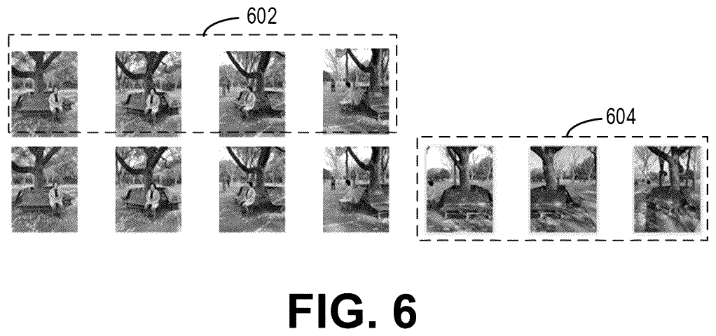

FIG. 6 illustrates a schematic diagram of an example inference for an image of a next view angle using an image sequence. As shown in FIG. 6, after the training of the three-dimensional scene model using the existing images 602 in the image sequence is completed, the three-dimensional scene model can generate the target image 604 corresponding to the next view angle.

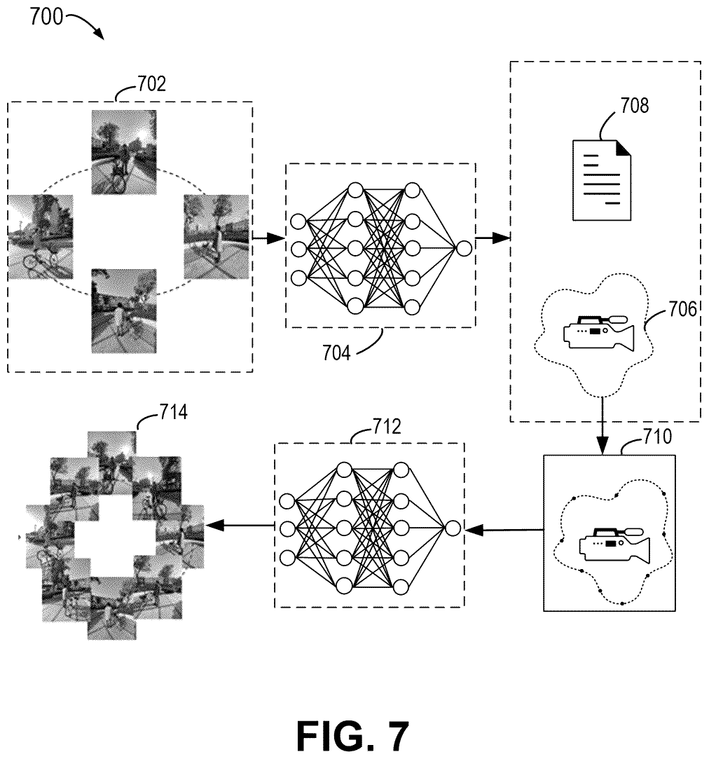

In some embodiments, in order to increase the frame rate of an image sequence or a video sequence to enrich the three-dimensional information of the target scene contained in the image sequence or the video sequence, a three-dimensional scene model may be used to generate two-dimensional images from particular view angles for data interpolation of the image sequence or the video sequence. FIG. 7 illustrates a schematic diagram of a process 700 for interpolating a video sequence using a three-dimensional scene model. As shown in FIG. 7, a video sequence 702 captured by an image capturing device may be input to a three-dimensional scene model 704 to train the three-dimensional scene model 704. As an example, during the training process, the three-dimensional scene model 704 may be used to learn and reconstruct the three-dimensional structure of the three-dimensional scene hidden in the video sequence 702.

As shown in FIG. 7, after the training of the three-dimensional scene model 704 is completed, a camera movement trajectory file 706 corresponding to this video sequence 702 and a network parameter file 708 of the three-dimensional scene model can be obtained. On this basis, the camera movement trajectory file 706 can be interpolated to determine a plurality of target camera poses and target view angles 710. The target camera poses and target view angles 710 are inputted to the trained three-dimensional scene model 712, and a corresponding target image is outputted from the three-dimensional scene model 712. It can be understood that the view angle corresponding to the target image is different from the view angle corresponding to each image in the image sequence. The generated target image is inserted into the video sequence 702 to determine an interpolated video sequence 714.

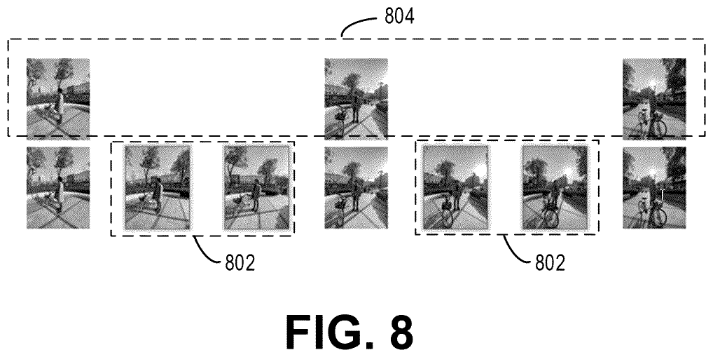

FIG. 8 illustrates a schematic diagram of interpolating a video sequence. As shown in FIG. 8, generated target images 802 may be inserted into an original video sequence 804 in the order of view angles to obtain an interpolated video sequence. In this way, the frame rate of the interpolated video sequence is greater than the frame rate of the original video sequence, and the interpolated video sequence contains a greater number of images and richer scene information.

In some embodiments, in the process of determining the target compressed image feature, in order to improve the quality and accuracy of the generation of the target image, the first compressed image feature corresponding to the view angle to the left of the target view angle and the second compressed image feature corresponding to the view angle to the right may be fused to determine a fused target compressed image feature. In this way, the image information contained in the determined target compressed image feature is richer and more accurate.

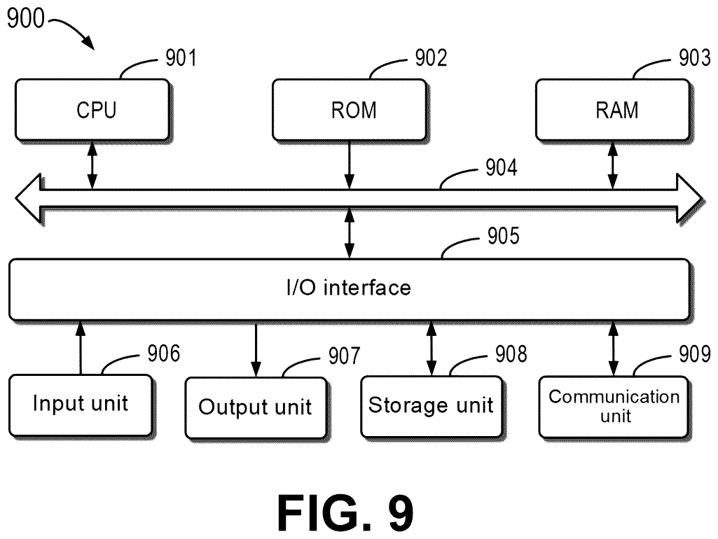

FIG. 9 illustrates a block diagram of an example device 900 which can be used to implement an embodiment of the present disclosure. Nodes in FIG. 1 may be implemented by the device 900. As shown in the figure, the device 900 includes a central processing unit (CPU) 901 which may perform various appropriate actions and processing according to computer program instructions stored in a read-only memory (ROM) 902 or computer program instructions loaded from a storage unit 908 to a random access memory (RAM) 903. Various programs and data required for the operation of the device 900 may also be stored in the RAM 903. The CPU 901, the ROM 902, and the RAM 903 are connected to one another through a bus 904. An input/output (I/O) interface 905 is also connected to the bus 904.

A plurality of components in the device 900 are connected to the I/O interface 905 and include: an input unit 906, such as a keyboard and a mouse; an output unit 907, such as various types of displays and speakers; a storage unit 908, such as a magnetic disk and an optical disc; and a communication unit 909, such as a network card, a modem, and a wireless communication transceiver. The communication unit 909 allows the device 900 to exchange information/data with other devices via a computer network, such as the Internet, and/or various telecommunication networks.

The various processes and processing described above, such as the method 400, may be performed by the CPU 901. For example, in some embodiments, the method 400 may be implemented as a computer software program that is tangibly included in a machine-readable medium, such as the storage unit 908. In some embodiments, part or all of the computer program may be loaded and/or installed onto the device 900 via the ROM 902 and/or the communication unit 909. When the computer program is loaded into the RAM 903 and executed by the CPU 901, one or more actions of the method 400 described above may be executed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by using status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, another programmable data processing apparatus, or another device, so that a series of operating steps can be performed on the computer, the other programmable data processing apparatus, or the other device to produce a computer-implemented process, such that the instructions executed on the computer, the other programmable data processing apparatus, or the other device can implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts and a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for image generation for a particular view angle, the method comprising:
acquiring a three-dimensional scene model, a target camera pose, and a target view angle corresponding to a target scene;
determining a target compressed image feature corresponding to the target camera pose and the target view angle from a plurality of compressed image features; and
inputting the target camera pose, the target view angle, and the target compressed image feature to the three-dimensional scene model, and obtaining a target image corresponding to the target camera pose and the target view angle through rendering by the three-dimensional scene model.

2. The method according to claim 1, wherein the three-dimensional scene model comprises a neural radiance field module, and said obtaining a target image corresponding to the target camera pose and the target view angle through rendering by the three-dimensional scene model comprises:
determining, using the neural radiance field module, corresponding color values and density values according to the target view angle and the target camera pose; and
obtaining the target image corresponding to the target camera pose and the target view angle through rendering by the neural radiance field module based on the color values, the density values, and the target compressed image feature.

3. The method according to claim 2, wherein the neural radiance field module further comprises a first multi-layer perceptron layer and a second multi-layer perceptron layer, and said obtaining the target image corresponding to the target camera pose and the target view angle through rendering by the three-dimensional scene model based on the color values, the density values, and the target compressed image feature comprises:
inputting the target camera pose and the target view angle to the first multi-layer perceptron layer, and outputting the corresponding color values and density values by the first multi-layer perceptron layer; and
inputting the color values, the density values, and the target compressed image feature to the second multi-layer perceptron layer, and outputting the target image corresponding to the target camera pose and the target view angle by the second multi-layer perceptron layer.

4. The method according to claim 1, wherein said acquiring a target camera pose and a target view angle comprises:
receiving an image generation instruction from a user; and
determining the target camera pose and the target view angle based on the image generation instruction.

5. The method according to claim 1, wherein said acquiring a target camera pose and a target view angle comprises:
acquiring a camera movement trajectory for the target scene; and
generating the target camera pose and the target view angle by interpolating the camera movement trajectory.

6. The method according to claim 1, further comprising:
acquiring an image sample sequence comprising a plurality of image samples obtained by photographing the same scene at different positions using different view angles;
constructing a three-dimensional scene model, which is configured with training parameters;
inputting the image samples separately to the three-dimensional scene model to obtain a corresponding rendered image outputted from the three-dimensional scene model, the rendered image being obtained through rendering according to compressed image features corresponding to the image samples; and
adjusting the training parameters iteratively based on differences between the rendered image and the sample images until the differences satisfy a preset requirement.

7. The method according to claim 6, wherein the three-dimensional scene model comprises a feature extraction module and a neural radiance field module, and said inputting the image samples separately to the three-dimensional scene model to obtain a corresponding rendered image outputted from the three-dimensional scene model comprises:
determining position embeddings corresponding to the image samples by encoding the image samples using the feature extraction module;
obtaining the compressed image features by compressing the position embeddings using the feature extraction module based on a preset compression coefficient; and
inputting camera poses, view angles, and the compressed image features corresponding to the image samples to the neural radiance field module, and obtaining the corresponding rendered image through rendering by the neural radiance field module.

8. The method according to claim 6, further comprising:
acquiring a camera movement trajectory after training of the three-dimensional scene model is completed; and
storing the camera movement trajectory, the compressed image features corresponding to the plurality of image samples, and the trained three-dimensional scene model.

9. The method according to claim 1, wherein said determining a target compressed image feature corresponding to the target camera pose and the target view angle comprises:
determining a first candidate camera pose, a first candidate view angle, a second candidate camera pose, and a second candidate view angle matching the target camera pose and the target view angle;
determining a first candidate compressed image feature corresponding to the first candidate camera pose and the first candidate view angle;
determining a second candidate compressed image feature corresponding to the second candidate camera pose and the second candidate view angle; and
determining the target compressed image feature by fusing the first candidate compressed image feature and the second candidate compressed image feature.

10. An electronic device for model processing, comprising:
at least one processor; and
a memory coupled to the at least one processor and having instructions stored thereon, wherein the instructions, when executed by the at least one processor, cause the electronic device to perform actions comprising:
acquiring a three-dimensional scene model, a target camera pose, and a target view angle corresponding to a target scene;
determining a target compressed image feature corresponding to the target camera pose and the target view angle from a plurality of compressed image features; and
inputting the target camera pose, the target view angle, and the target compressed image feature to the three-dimensional scene model, and obtaining a target image corresponding to the target camera pose and the target view angle through rendering by the three-dimensional scene model.

11. The electronic device according to claim 10, wherein the three-dimensional scene model comprises a neural radiance field module, and said obtaining a target image corresponding to the target camera pose and the target view angle through rendering by the three-dimensional scene model comprises:
determining, using the neural radiance field module, corresponding color values and density values according to the target view angle and the target camera pose; and
obtaining the target image corresponding to the target camera pose and the target view angle through rendering by the neural radiance field module based on the color values, the density values, and the target compressed image feature.

12. The electronic device according to claim 11, wherein the neural radiance field module comprises a first multi-layer perceptron layer and a second multi-layer perceptron layer, and said obtaining the target image corresponding to the target camera pose and the target view angle through rendering by the three-dimensional scene model based on the color values, the density values, and the target compressed image feature comprises:
inputting the target camera pose and the target view angle to the first multi-layer perceptron layer, and outputting the corresponding color values and density values by the first multi-layer perceptron layer; and
inputting the color values, the density values, and the target compressed image feature to the second multi-layer perceptron layer, and outputting the target image corresponding to the target camera pose and the target view angle by the second multi-layer perceptron layer.

13. The electronic device according to claim 10, wherein said acquiring a target camera pose and a target view angle comprises:
receiving an image generation instruction from a user; and
determining the target camera pose and the target view angle based on the image generation instruction.

14. The electronic device according to claim 10, wherein said acquiring a target camera pose and a target view angle comprises:
acquiring a camera movement trajectory for the target scene; and
generating the target camera pose and the target view angle by interpolating the camera movement trajectory.

15. The electronic device according to claim 10, further comprising:
acquiring an image sample sequence comprising a plurality of image samples obtained by photographing the same scene at different positions using different view angles;
constructing a three-dimensional scene model, which is configured with training parameters;
inputting the image samples separately to the three-dimensional scene model to obtain a corresponding rendered image outputted from the three-dimensional scene model, the rendered image being obtained through rendering according to compressed image features corresponding to the image samples; and
adjusting the training parameters iteratively based on differences between the rendered image and the sample images until the differences satisfy a preset requirement.

16. The electronic device according to claim 15, wherein the three-dimensional scene model comprises a feature extraction module and a neural radiance field module, and said inputting the image samples separately to the three-dimensional scene model to obtain a corresponding rendered image outputted from the three-dimensional scene model comprises:
determining position embeddings corresponding to the image samples by encoding the image samples using the feature extraction module;
obtaining the compressed image features by compressing the position embeddings using the feature extraction module based on a preset compression coefficient; and
inputting camera poses, view angles, and the compressed image features corresponding to the image samples to the neural radiance field module, and obtaining the corresponding rendered image through rendering by the neural radiance field module.

17. The electronic device according to claim 15, wherein the actions further comprise:
acquiring a camera movement trajectory after training of the three-dimensional scene model is completed; and
storing the camera movement trajectory, the compressed image features corresponding to the plurality of image samples, and the trained three-dimensional scene model.

18. The electronic device according to claim 10, wherein said determining a target compressed image feature corresponding to the target camera pose and the target view angle comprises:
determining a first candidate camera pose, a first candidate view angle, a second candidate camera pose, and a second candidate view angle matching the target camera pose and the target view angle;
determining a first candidate compressed image feature corresponding to the first candidate camera pose and the first candidate view angle;
determining a second candidate compressed image feature corresponding to the second candidate camera pose and the second candidate view angle; and
determining the target compressed image feature by fusing the first candidate compressed image feature and the second candidate compressed image feature.

19. A computer program product that is tangibly stored on a non-transitory computer-readable medium and comprises machine-executable instructions, wherein the machine-executable instructions, when executed by a machine, cause the machine to perform a method, the method comprising:
acquiring a three-dimensional scene model, a target camera pose, and a target view angle corresponding to a target scene;
determining a target compressed image feature corresponding to the target camera pose and the target view angle from a plurality of compressed image features; and
inputting the target camera pose, the target view angle, and the target compressed image feature to the three-dimensional scene model, and obtaining a target image corresponding to the target camera pose and the target view angle through rendering by the three-dimensional scene model.

20. The computer program product according to claim 19, wherein the three-dimensional scene model comprises a neural radiance field module, and said obtaining a target image corresponding to the target camera pose and the target view angle through rendering by the three-dimensional scene model comprises:
determining, using the neural radiance field module, corresponding color values and density values according to the target view angle and the target camera pose; and
obtaining the target image corresponding to the target camera pose and the target view angle through rendering by the neural radiance field module based on the color values, the density values, and the target compressed image feature.
